(19) United States
(12) Patent Application Publication
(10) Pub. No.: US 2018/0365647 A1
(43) Pub. Date: Dec. 20, 2018

(54) SOCIAL MEDIA INTEGRATED RECRUITING SERVICE

(71) Applicant: SAP SE, Walldorf (DE)

(72) Inventors: Lei Huang, Shanghai (CN); Terry Gu, Shanghai (CN); Fiona Wang, Shanghai (CN); Wenchang Zhang, Shanghai (CN); Lyn Zhao, Shanghai (CN); Lisa Shen, Shanghai (CN); Haibin Yuan, Shanghai (CN)

(21) Appl. No.: 15/623,118

(22) Filed: Jun. 14, 2017

(51) Int. Cl. G06Q 10/10; G06Q 50/00

(52) U.S. Cl. CPC G06Q 10/1053; G06Q 50/01

(57) ABSTRACT

A system includes a memory and a semiconductor-based processor. The memory and the processor host a social media integration service for an internal human resources system of an organization. The social media integration service couples user interactions of an external social media platform with the internal human resources system of the organization.

### BACKGROUND

Computing software and systems are used to solve the needs or problems of an organization. Such organizations may include businesses, schools, interest-based user groups, clubs, charities, or governments. For example, computer software (also known as enterprise application software (EAS)) running on enterprise resource planning (ERP) systems can be used to address problems in many areas (e.g., in product planning, purchase, production planning; human resource planning; manufacturing or service delivery; marketing and sales; materials management; inventory management; shipping and payment; finance, etc.) of an organization.

ERP systems of an organization are traditionally run on a variety of computer hardware (e.g., mainframe computer systems, desktop systems, etc.) and network configurations, typically using a database as an information repository. An ERP system (e.g., a human resources (HR) software and management system) may, for example, be run by HR personnel to manage human resources of an organization.

Over the last few decades there have been dramatic developments in computer and communication technologies (e.g., business and personal computing, cloud computing, the Internet, mobile computing (e.g., smart phones), and social media networking, etc.) that have provided new computing and communication capabilities. Social networking services (e.g., online social media platform) are now widely used by people to communicate and build social networks or social relations with other people who share similar personal or career interests, activities, backgrounds or real-life social connections.

Consideration is now being given to incorporating social media networking services or social media technology in ERP systems that address the needs and problems of an organization.

### SUMMARY

A system includes a memory and a semiconductor-based processor. The memory and the processor host a social media integration service for an internal human resources system of an organization. The social media integration service couples user interactions of an external social media platform with the internal human resources system of the organization.

In an aspect, the social media integration service is hosted on a cloud computing platform that includes a database configured to store data received from the external social media platform.

In an aspect, the social media integration service is configured to import resumes received at the external social media platform into a database of internal human resources system of the organization.

In an aspect, the social media integration service receives a resume in one of several different formats, parses the received resume, and reassembles the parsed resume for import into the database of the internal human resources system of the organization.

In an aspect, the social media integration service connects, via a user interface of a cloud computing platform, to the internal human resources system of the organization.

In an aspect, the social media integration service presents an internal user interface with functions for an internal user of the internal human resources system of the organization and an external user interface with functions for a user of the external social media platform.

In an aspect, the social media integration service presents the internal user interface with user interface elements that allow the internal user to configure input data to be mapped to a required data format of the internal human resources system of the organization.

In an aspect, social media integration service presents the external user interface with user interface elements that allow the external user to browse job openings published on the social media, filter the job openings, and apply for a job opening on the social media via the external user interface.

In an aspect, the social media integration service presents the external user interface with user interface elements that allow the external user to review and edit his or her resume.

The details of one or more implementations are set forth in the accompanying drawings and the description below. Further features of the disclosed subject matter, its nature and various advantages will be more apparent from the accompanying drawings, the following detailed description, and the appended claims.

### BRIEF DESCRIPTION OF THE DRAWINGS

FIG. 1 is a schematic block diagram illustration is a schematic block diagram of a human resources system that includes or is coupled to a social media recruiting system, in accordance with the principles of the present disclosure.

FIG. 2 is an architectural diagram showing the layers and components of an example social media recruiting service coupled to an internal human resources system of an organization, in accordance with the principles of the present disclosure.

FIG. 3 is an illustration of a process for integrating resumes and other job application data received via social media into an internal human resources system of an organization, in accordance with the present disclosure.

FIG. 4 is an illustration of an example process by which an applicant may create or submit a resume for a job application via a social media recruiting service coupled to an internal human resources system of an organization, in accordance with the present disclosure.

FIG. 5 is an overview architectural layer diagram illustrating an example data model mapping process in accordance with the principles of the present disclosure.

FIG. 6 is a screen shot of an example launch screen of a hiring service that may be presented to human resources users of a social media integration application, in accordance with the principles of the present disclosure.

FIG. 7 is a screen shot of an example desktop UI screen of a hiring service that may be presented to human resources users of a social media integration application, in accordance with the principles of the present disclosure.

FIG. 8 is a screen shot of an example desktop UI screen of a hiring service that may be presented to human resources users of a social media integration application, in accordance with the principles of the present disclosure.

FIG. 9 is a screen shot of an example desktop UI screen of a hiring service that may be presented to human resources users of a social media integration application, in accordance with the principles of the present disclosure.

FIG. 10 is a screen shot of an example desktop UI screen of a hiring service that may be presented to human resources users of a social media integration application, in accordance with the principles of the present disclosure.

FIG. 11 is a screen shot of an example mobile device UI screen of a hiring service that may be presented to mobile device users of a social media integration application, in accordance with the principles of the present disclosure.

FIG. 12 is a screen shot of an example mobile device UI screen of a hiring service that may be presented to mobile device users of a social media integration application, in accordance with the principles of the present disclosure.

FIG. 13 is a screen shot of an example mobile device UI screen of a hiring service that may be presented to mobile device users of a social media integration application, in accordance with the principles of the present disclosure.

FIG. 14 is a screen shot of an example mobile device UI screen of a hiring service that may be presented to mobile device users of a social media integration application, in accordance with the principles of the present disclosure.

### DETAILED DESCRIPTION

A human resources (HR) software and management system, which may be cloud-based, can help an organization (and HR information systems (HRIS) departments of the organization) keep track of personnel or employees (e.g., who is who, where they are based, what jobs they are doing, and how they are doing the jobs, etc.) in an integrated or centralized manner (negating the need for different HR managing efforts at different locations or in different operations of the organization). For brevity and convenience in description, the human resources (HR) software and management system may be referred to as “the HR system” herein.

The HR system of the organization may include basic HR functions, for example, maintaining an employee database, archiving personnel records, and producing directories and organizational charts. In this way, the HR system may act as the organization's system of record for all things people-related. Because the HR system software may be built on an integrated database of personnel information, the software may produce reports that HR departments or administrators can use to analyze vital workforce metrics such as staffing allocations, compensation costs, and turnover. In example implementations, the HR system may include a recruiting system (e.g., SAP's SuccessFactors Recruiting), which provides functions for applicant tracking and for hiring and staffing the organization (e.g., by tracking job openings, processing candidate or applicant resumes, and hiring personnel, etc.). The HR system (e.g., SAP's SuccessFactors Recruiting) may include processes that are designed to run on, for example, enterprise-scale computing systems (e.g., mainframe computers, desktop computers, etc.), and to be used by designated personnel of the organization (e.g., HR personnel).

Execution of the HR system (e.g., SuccessFactors Recruiting) may be limited to the computing systems (e.g. mainframe computers, desktop computers, etc.) of the organization. Further, the HR system may be designed for only internal use within the organization with use limited to the designated personnel (e.g., HR personnel) having access to the organization's computing systems. For convenience in description, such an HR system (e.g., SuccessFactors Recruiting) may be referred to herein as an “internal HR system” of the organization.

In accordance with the principles of the disclosure herein, the internal HR system of an organization may further include or be coupled to a social media recruiting system. The social media recruiting system may provide processes to integrate social media interactions and access with the processes of the internal HR system (that may be otherwise designed to run on enterprise-scale computing systems of the organization).

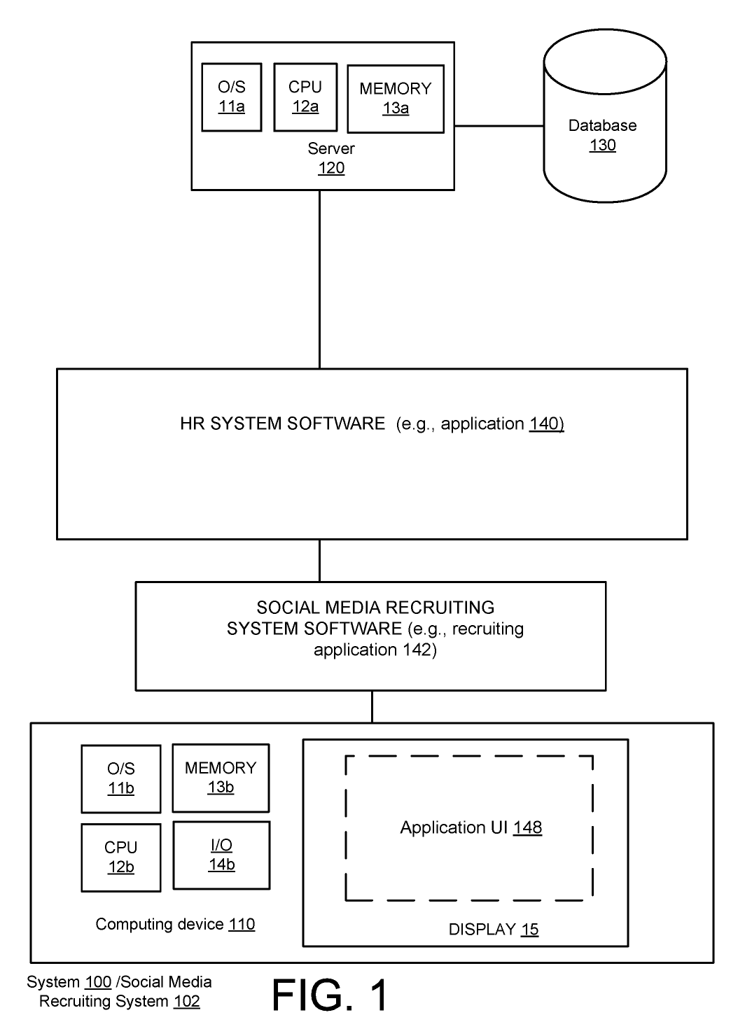

FIG. 1 is a schematic block diagram of a HR system 100 that includes or is coupled to a social media recruiting system 102, in accordance with the principles of the present disclosure.

System 100 may include a backend computer system (e.g., server 120), which is connected, for example, to client computing device 110 and one or more databases (e.g., database 130). Client computing device 110 may, for example, include an O/S 11b, a CPU 12b, a memory 13b, and an I/O 14b, and a user interface (UI) or display 15. Server 120, like client computing device 110, may include computer components such as an O/S 11a, a CPU 12a, and a memory 13a, etc. Client computing device 110 may be used, for example, by users to interact with the HR system 100.

Although server 120 is illustrated in the example of FIG. 1 as a single computing device, it may be understood that server 120 may represent two or more computing devices in communication with one another. Therefore, it will also be appreciated that any two or more components of system 100 and system 102 may similarly be executed using some or all of the two or more computing devices in communication with one another. Conversely, it also may be appreciated that various components illustrated as being external to server 120 may actually be implemented therewith.

In FIG. 1, for purposes of illustration, the HR software of system 100 may be represented, for example, by computer application 140. Further, as noted above, HR system 100 may include or be coupled to a social media recruiting system 102. In FIG. 1, for purposes of illustration, the software of social media recruiting system 102 may be represented, for example, by recruiting application 142. Computer application 140 and recruiting application 142 may be hosted on one or more computers (including, for example, server 120, client computing device 110 or other virtual or physical machines).

A social media recruitment system (e.g., social media recruiting system 102), in accordance with the principles of the present disclosure, may have one or more of the following features: a tool supporting candidate profile import (e.g. periodic imports) to a system database; functionality for parsing resumes; integration with local online job boards (e.g., China online job boards such as 51job, Dajie, Liepin, etc.) that list or display job openings or employment opportunities; and, integration with one or more social media platforms (e.g. Facebook, Tencent's MyChat, etc.). The integration with the one or more social media platform may provide users (e.g., HR personnel, job applicants) with a better online job application experience.

In example implementations, social media recruiting system 102 may be configured as a social media “recruiting service” or “hiring service” that is coupled to a HR software and management system of an organization, in accordance with the principles of the present disclosure. The recruiting or hiring service may integrate user's social media interactions with the recruiting functions of the HR software and management system that may be otherwise limited or internal to the organization.

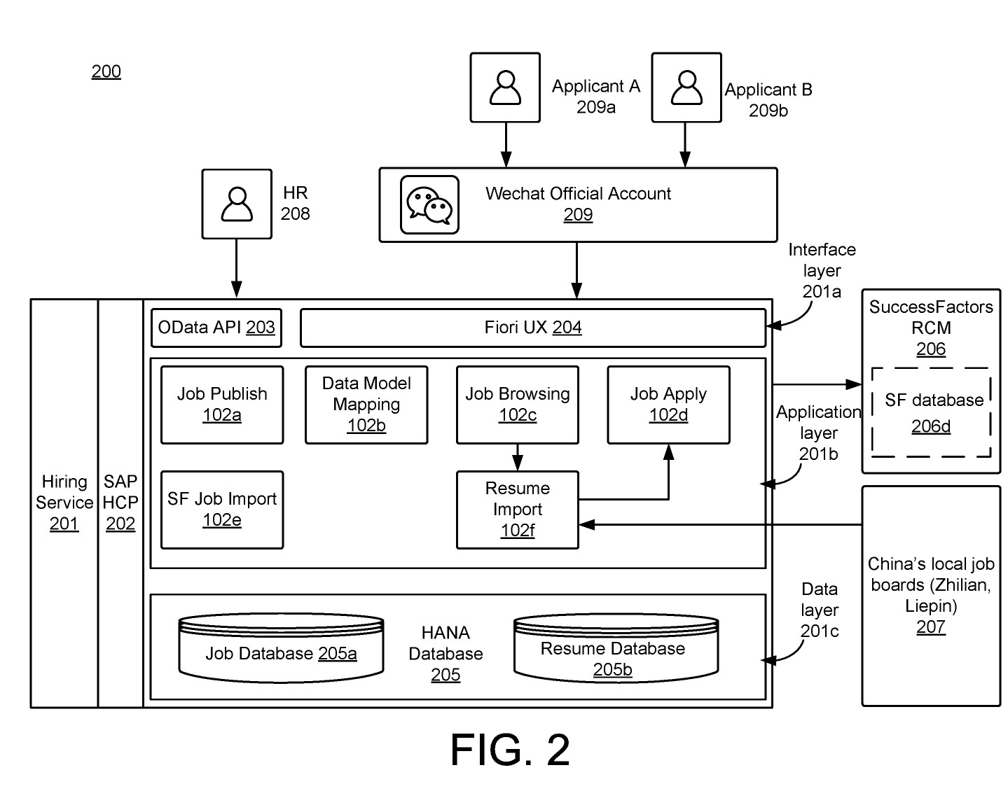

FIG. 2 is an architectural diagram 200 showing the layers and components of an example social media recruiting service (e.g., hiring service 201), in accordance with the principles of the present disclosure.

Hiring service 201 may be hosted on a cloud-computing platform 202 (e.g., a SAP Hana Cloud Platform (HCP)). Hiring service 201 may be provided, for example, to account holders or subscribers of computing platform 202. Hiring service 201 may be exposed to an internal HR recruiting software and management system (e.g., SAP SuccessFactors Recruiting Management (RCM) 206) and connected to online job boards (e.g., China's Local Job Boards 207) via an API (e.g., OData 203). The internal HR recruiting software and management system (e.g., SAP SuccessFactors RCM 206) may include a database (e.g., SF database 206d) for storing applicant and job openings related data.

From an architectural perspective, hiring service 201 may include an interface layer 201a, an application layer 201b, and a data layer 201c.

Interface layer 201a may, for example, include an OData API 203, and a computing platform user interface (UI) (e.g., Fiori UX 204). The computing platform UI (e.g., Fiori UX 204) may allow porting of applications on to mobile devices. Organizational users (e.g., HR 208) may access functions of hiring service 201 via interface layer 201a. Social media network platforms (social media 209 (e.g., Wechat official account)) also may be exposed to hiring service 201 via interface layer 201a. Social media users (e.g., Applicant A 209a, Applicant B 209b) on social media network platforms (e.g., social media 209 (e.g., Wechat official account)) may access functions of hiring service 201 via their social media network accounts connected to interface layer 201a.

Data layer 201c may include access to jobs data and applicant resume data that may be available, for example, in a jobs database 205a and a resume database 205b, respectively. Jobs database 205a and resume database 205b may, for example, be included in a database system (e.g., HANA database 205) that may be maintained by, for example, by cloud-computing platform 202.

Application layer 201b may include modules (e.g., Job Publish 102a, Data Model Mapping 102b, Job Browsing 102c, Job Apply 102d, SF Job Import 102e and resume import 102f) of application 142. These modules may include methods that are configured to enable features such as: candidate profile import (e.g. periodic imports) to a system database; parsing resumes; integration with local online job boards; and integration with one or more social media platforms.

Application layer 201b (e.g., module SF job import 102e) may include methods that enable HR users (e.g., HR 208) to import applicant or candidate resumes in diverse formats (e.g., DOC, HTML, etc.) directly into SuccessFactors RCM 206. The applicant or candidate resumes may be imported by the HR users from any source. If a Job Requisition ID is specified for the candidates during the data importation, SuccessFactors RCM 206 may automatically generate a corresponding candidate profile along with the automatic generation of a job application record.

Applicants (e.g., Applicant A 209a) may apply for a job opening, which may be published on social media, for example, by Job Publish 102a. An applicant may apply for the job opening, and complete a job application, for example, by uploading his or her resume. The applicant may upload his or her resume, which may be stored in local job boards (e.g., China's Local Job Boards 207). By uploading the stored resume, the applicant need not take the effort to create his or her resume each time the applicant applies for a job opening.

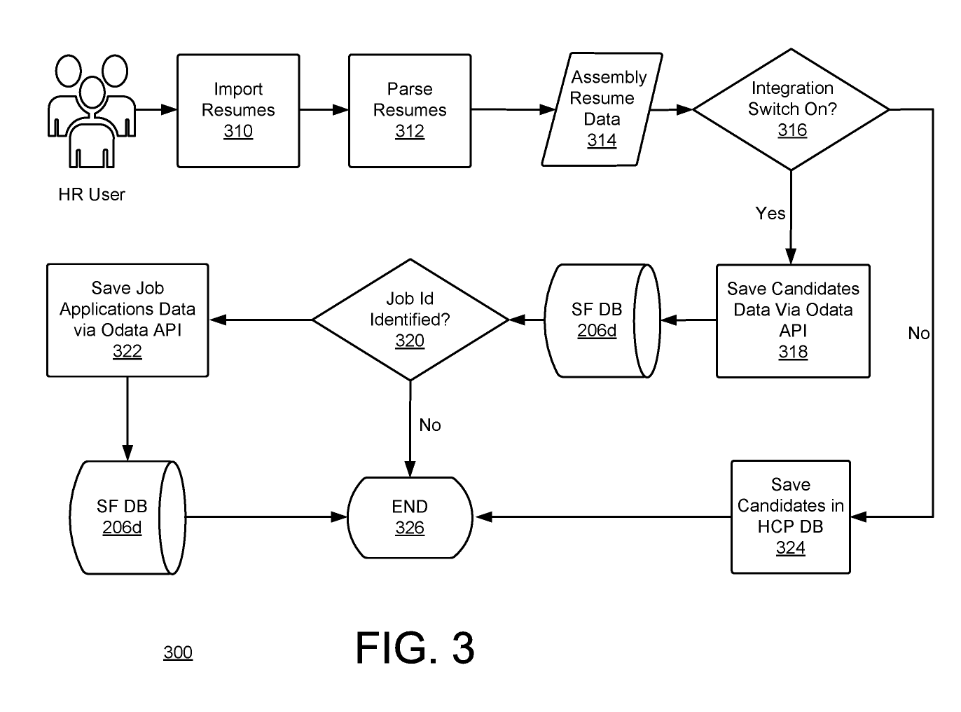

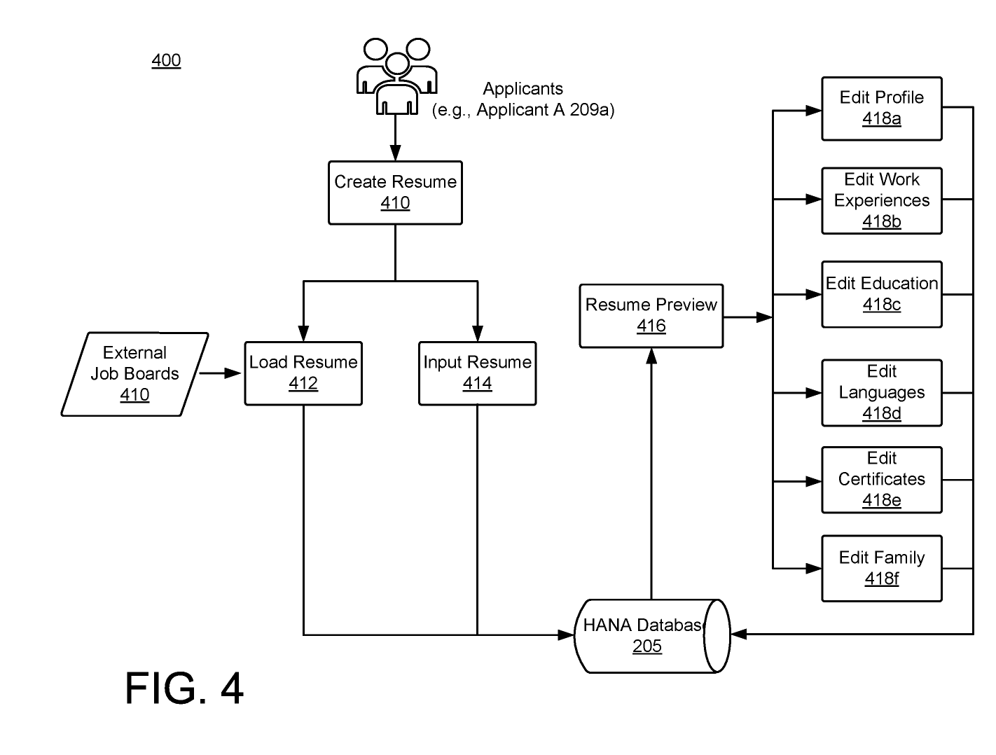

The operations of the various modules in application layer 201b (e.g., Job Publish 102a, Data Model Mapping 102b, Job Browsing 102c, Job Apply 102c, SF Job Import 102e and resume import 102f) are further described herein with reference to FIGS. 3 and 4.

FIG. 3 shows a process 300 in application layer 201b for integrating resumes and other job application data received via social media 209 into SAP SuccessFactors RCM 206, in accordance with the present disclosure. Process 300 may be initiated by HR users (e.g. HR 208).

Process 300, may begin with an import of resumes (and other candidate or applicant data) from the social media (e.g., social media 209) (310), and parsing of the imported resumes (312). Process 300 may further include assembling the parsed resume data (314). The assembled resume data may have a format that is the same as or is compatible with the data format used to store resumes in SuccessFactors RCM 206 (e.g., in SF database 206d). Process 300, at 316, may involve determining if an integration switch is on. If the integration switch is on, process 300 may involve saving candidate or applicant data (including reformatted resumes) in SF database 206d (320). The data may be saved to SF database 206d, for example, via OData API 203. If at 316, it is determined that integration switch is not on, process 300 may involve, at 324, saving candidate or applicant data in the database system (e.g., HANA database 205) that may be maintained by cloud-computing platform 202 (before process 300 ends at 326). If at 316 the integration switch is on, process 300 may involve saving candidate or applicant data (including reformatted resumes) in SF database 206d (318). The data may be saved to SF database 206d, for example, via OData API 203.

Further, process 300, at 320, may involve determining if a Job ID has been identified in the candidate or applicant data received from the social media (e.g., social media 209). If a Job ID has not been identified, process 300 may end at 326. If at 320 a Job ID has been identified, process 300 may involve saving the Job Applications data in SF database 206d (e.g., via OData API 203) at 322 (before process 300 ends at 326).

FIG. 4 shows an example process 400 of application layer 201b that an applicant can use to create or submit a resume for a job application via social media, in accordance with the present disclosure.

Process 400 may begin with the user (e.g., Applicant A 209a or Applicant B 209b) initiating, at 410, creation of a resume in application layer 201b of hiring service 201. The user may initiate creation of the resume via a social media platform (e.g., social media 209). In process 400, at 412, the applicant may upload a previously prepared resume from a local online job board (e.g., China's Local Job Boards 207). The local online job board may be an external recruitment website (e.g., Dajie, Liepin, 51job, etc.). Alternatively, at 414, the applicant may input a resume (e.g., by typing text, or uploading a resume from the applicant's personal computing device). In either case, after 412 or 414, the created resume may be stored in a database system (e.g., HANA database 205) that may be maintained by cloud-computing platform 202.

Process 400 may allow the applicant to review and edit his or her resume (and other applicant data) via the social media (e.g., social media 209 (e.g., Wechat official account)). The resumes may be stored, for example, in HANA database 205. Process 400, at 416, may enable the applicant to retrieve and preview his or her resume stored in HANA database 205. Further, process 400 may include the one or more editing features or options (e.g., Edit Profile 418a, Edit Work Experiences 418b, Edit Education 418c, Edit Languages 418d, Edit Certificates 418e, Edit Family 418f, etc.) that the applicant may use to modify or edit different portions of his or resume before it stored in HANA database 205.

The applicant may use or reuse his or her resume saved in HANA database 205 for an online job application via the social media (e.g., at 412 in process 400).

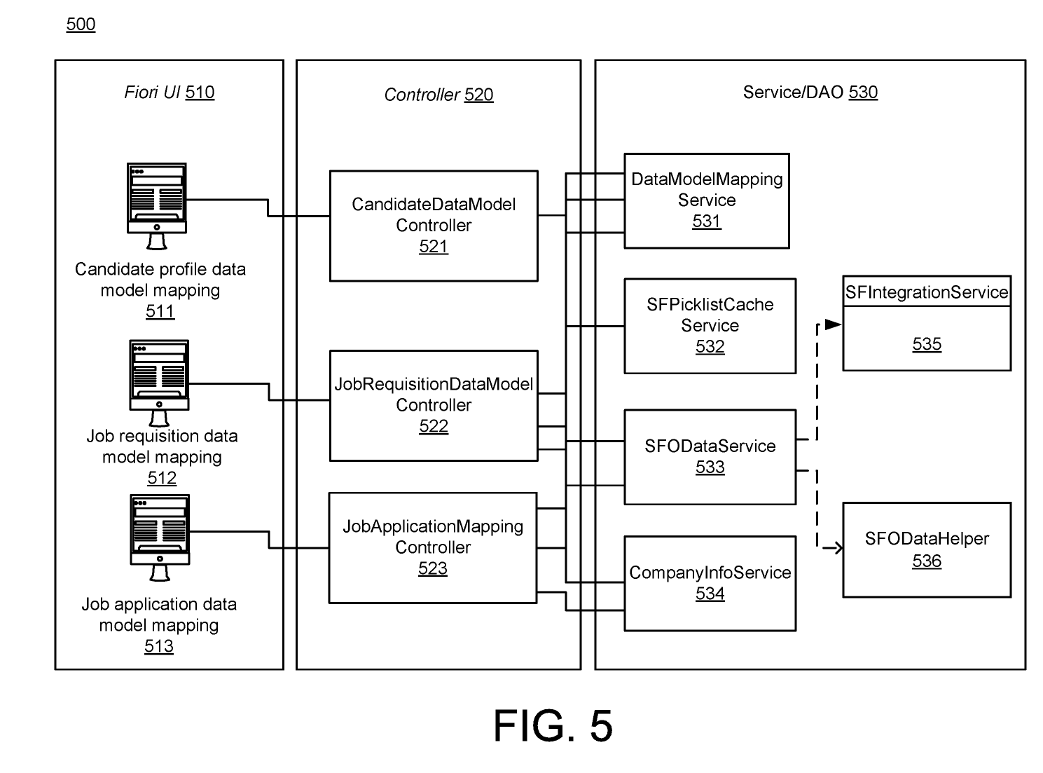

FIG. 5 is an overview architectural layer diagram illustrating an example data model mapping process 500 that may be included in application layer 201b in accordance with the principles of the present disclosure. Data model mapping process 500 may be used for mapping a backend data model used for resumes and job application data in the social media hiring service 201 on to the data model used in the internal HR system (e.g., SuccessFactors RCM 206).

Data model mapping process 500 may, for example, include a first layer (e.g., Fiori UI 510), a second layer (Controller 520), and a third layer (e.g., Service/Data Access Object (DAO) 530).

The first layer (e.g., Fiori UI 510) may include a Candidate Profile Data Model 511, a Job Requisition Data Model 512, and a Job Application Data Model 513 corresponding to a user interface (e.g., Fiori UI 204). The second layer (e.g., controller 520) may include a Candidate Data Model controller 521, a Job Requisition Data Model controller 521 and a Job Application Data Model controller 523. The third layer (e.g., Service/DAO 5300 may include a Data Model Mapping service 531, a SF picklist cache service 532, a SFOData service 533, and a Company Info service 534. SFOData service 533 may have as dependencies SFlntegration service 535 and SFOData Helper 536.

As shown in FIG. 5, controllers 521-523 in the second layer (e.g., controller 520) may modify or map the corresponding data models 511-513 in the first layer (e.g., Fiori UI 510) to one or more of services 531-534 of the third layer (e.g., services/DAO 530).

As the APIs (e.g., OData API 203) build up the connection between hiring service 201 and SuccessFactors RCM 206 during job application and job publication processes, the data posted through APIs must have certain format. Accordingly, hiring service 201 may enable HR users or system administrators (e.g. HR 208) to configure their input data to be mapped to the required data format of SuccessFactors RCM 206 using, for example, one or more services 531-536 of data model mapping process 500.

In an example implementation, social media recruiting system 102/hiring service 201 may present a desktop application user interface (“desktop UI” or “internal” UI) targeting internal users (e.g., HR personnel), and present a different mobile device application user interface (“mobile device UI” or “external” UI) targeting external users such as mobile device users/applicants (who may be using social media platforms such as WeChat with small screen mobile devices or smart phones).

The desktop UI (or “internal UI) may provide the users (e.g., HR personnel) functionalities for publishing job openings to the social media (e.g., g., social media 209), importing resumes received via the social media into the internal HR system (e.g., SuccessFactors RCM 206), monitoring online applications on the social media (e.g., WeChat), and displaying analytical reports. Further, recruiting system 102/hiring service 201 may include functionality for parsing resumes with a high degree of accuracy (e.g., 100% accuracy) and supporting collection of resumes of different format (e.g., DOC, HTML and MHT, etc.).

The mobile device UI (or external UI) may enable applicants using a mobile device to browse job openings published on the social media (e.g., by HR administrators), and filter the job openings using filter parameters. An applicant may apply for a job opening on the social media via the mobile device UI. To apply for the job opening the applicant may create a resume on the social media. Alternatively, the applicant may import an existing resume from local job boards (e.g., 51job, Dajie, Liepin, etc.). After a job application is completed, the resume together with the job application information may be stored in SuccessFactors RCM 206 via OData APIs 203. An “Apply History” feature in the mobile device UI may help an applicant track a status of his or her application in the hiring process.

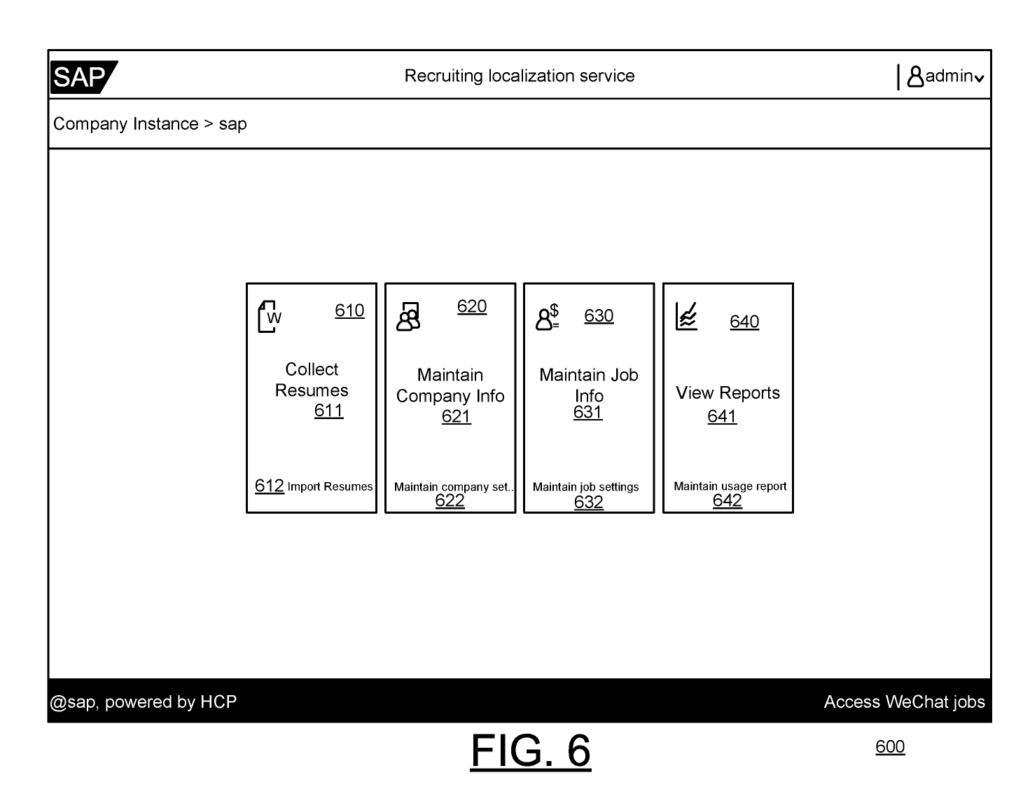

FIG. 6 shows an example launch screen 600 of hiring service 201 that may be presented to HR users (e.g., in application UI 148 on display 15 of client computing device 110) by application 142, in accordance with the principles of the present disclosure. Launch screen 600 may include user activable UI elements 610, 620, 630, and 640 that may respectively include links to: collect resumes 611 and import resumes 612; maintain company info 621 and maintain company settings 622; maintain job info 631 and maintain job settings 632; and view reports 641 and view WeChat reports 642.

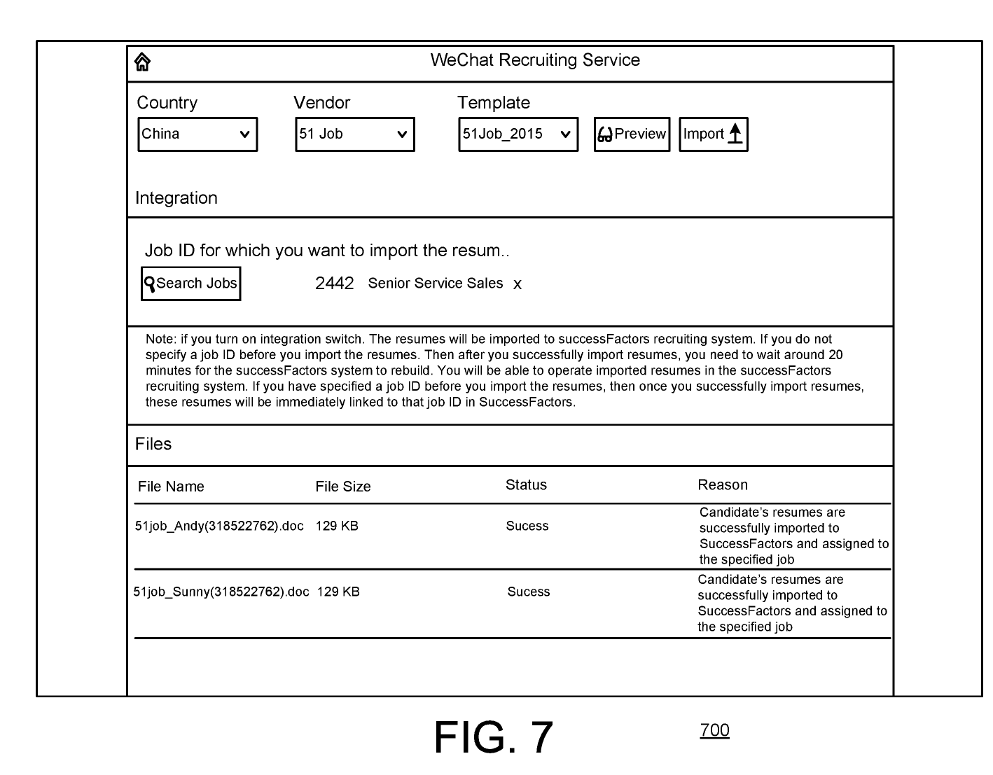

FIG. 7 shows an example desktop UI screen 700 of hiring service 201 that may be presented to HR users, in accordance with the principles of the present disclosure. Screen 700 may include UI elements that allow to import candidates' resumes into the internal HR system (e.g., SuccessFactors RCM 206), in accordance with the principles of the present disclosure.

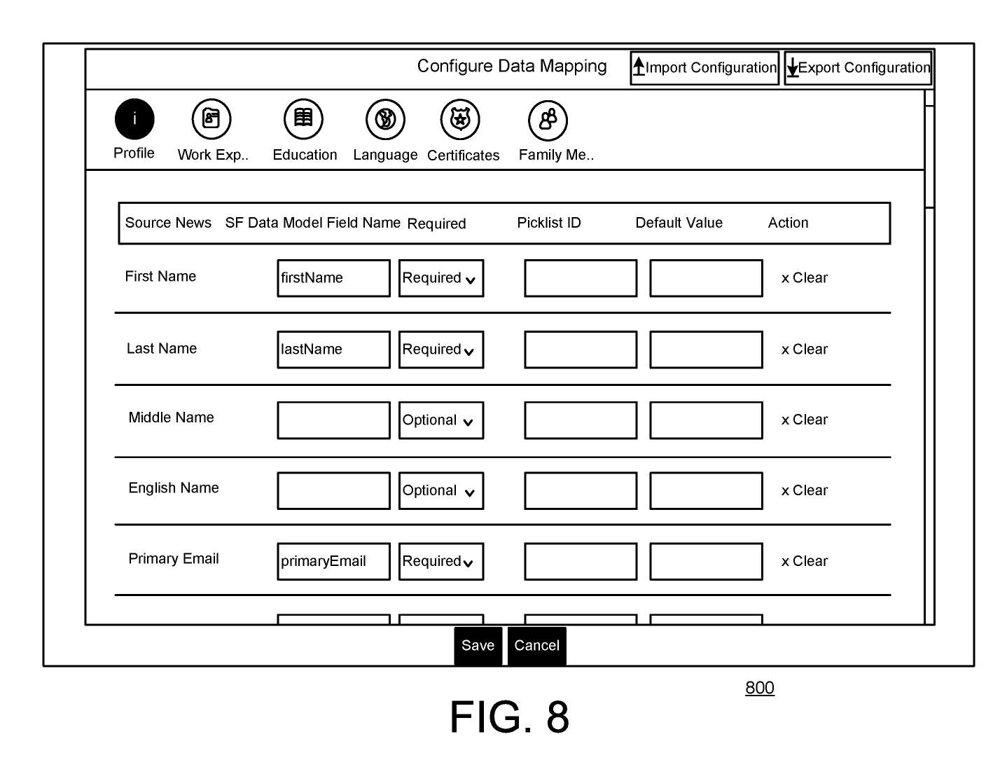

FIG. 8 shows an example desktop UI screen 800 of hiring service 201 that may be presented to HR users, in accordance with the principles of the present disclosure. Screen 800 may include UI elements that allow the HR user to configure their input data (e.g., data received over the social media) to be mapped to the required data format of the internal HR system (e.g., SuccessFactors RCM 206).

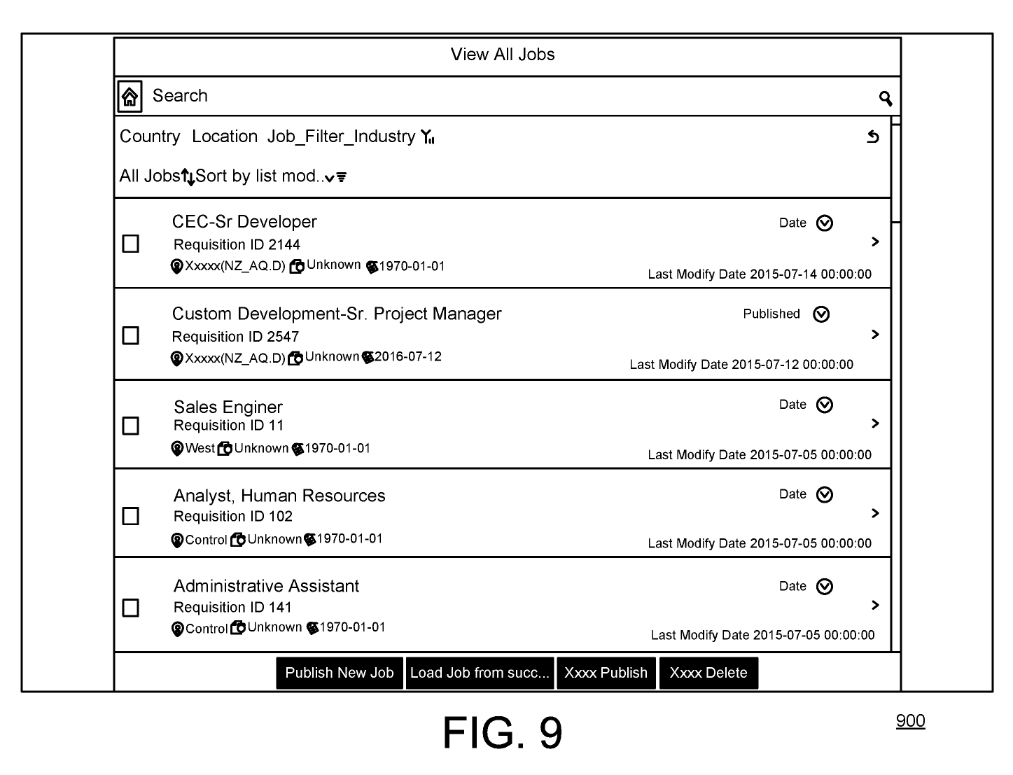

FIG. 9 shows an example desktop UI screen 900 of hiring service 201 that may be presented to HR users, in accordance with the principles of the present disclosure. Screen 900 may include UI elements that allow the HR users to synchronize the job openings in the internal HR system (e.g., SuccessFactors RCM 206) with those in HANA Database 205 for later publishing them to the social network.

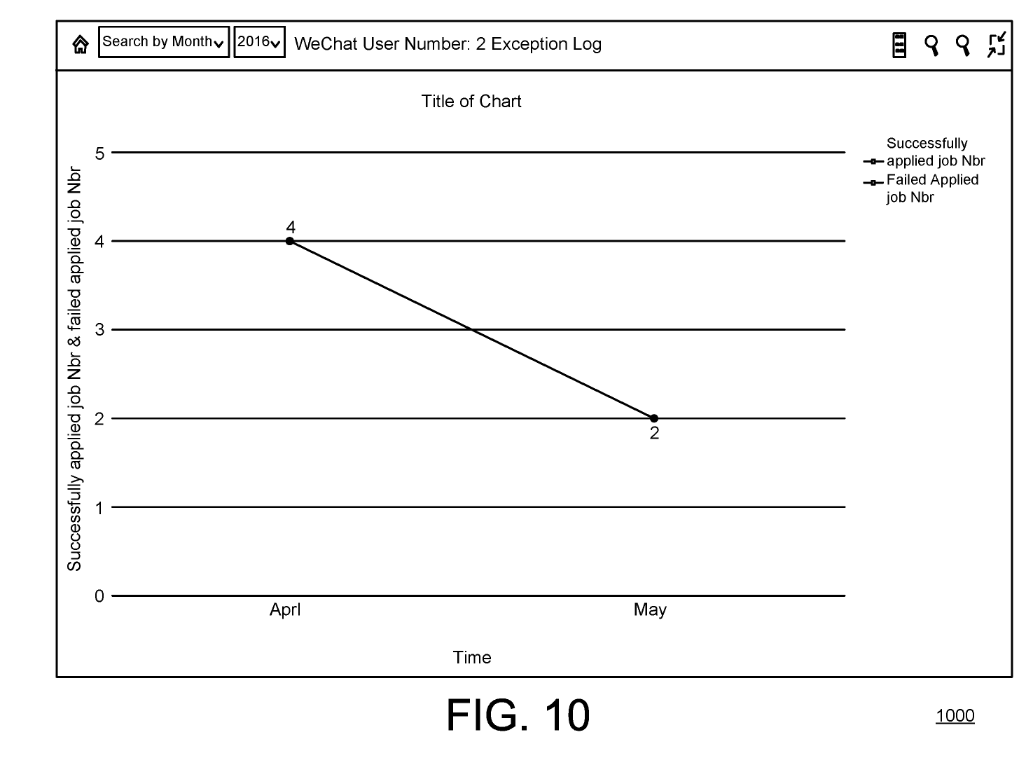

FIG. 10 shows an example desktop UI screen 1000 of hiring service 201 that may be presented to HR users, in accordance with the principles of the present disclosure. Desktop UI screen 1000 may display an analytical report, for example, a graph of the number of applicants applying for jobs through social network WeChat in different months of the year.

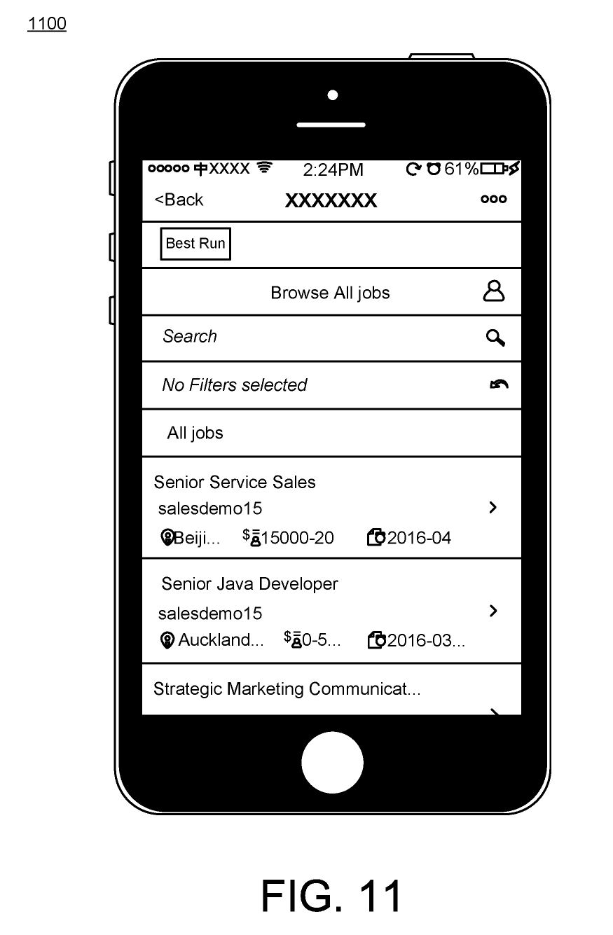

FIG. 11 shows an example mobile device UI screen 1100 of hiring service 201 that may be presented to mobile device users, in accordance with the principles of the present disclosure. Mobile device UI screen 1200 may include UI elements allow an applicant to browse for job openings.

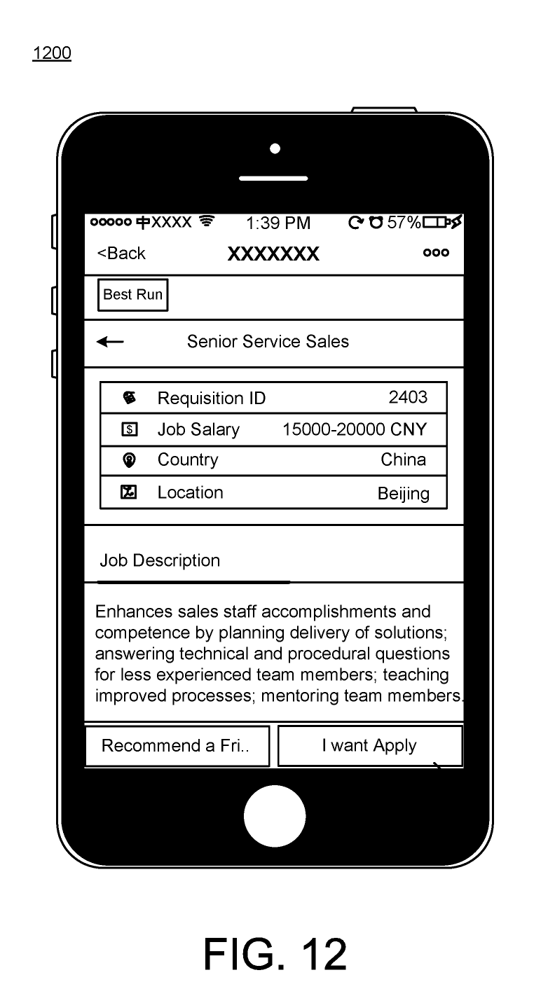

FIG. 12 shows an example mobile device UI screen 1200 of hiring service 201 that may be presented to mobile device users, in accordance with the principles of the present disclosure. Mobile device UI screen 1200 may include UI elements allow an applicant to apply for a job opening.

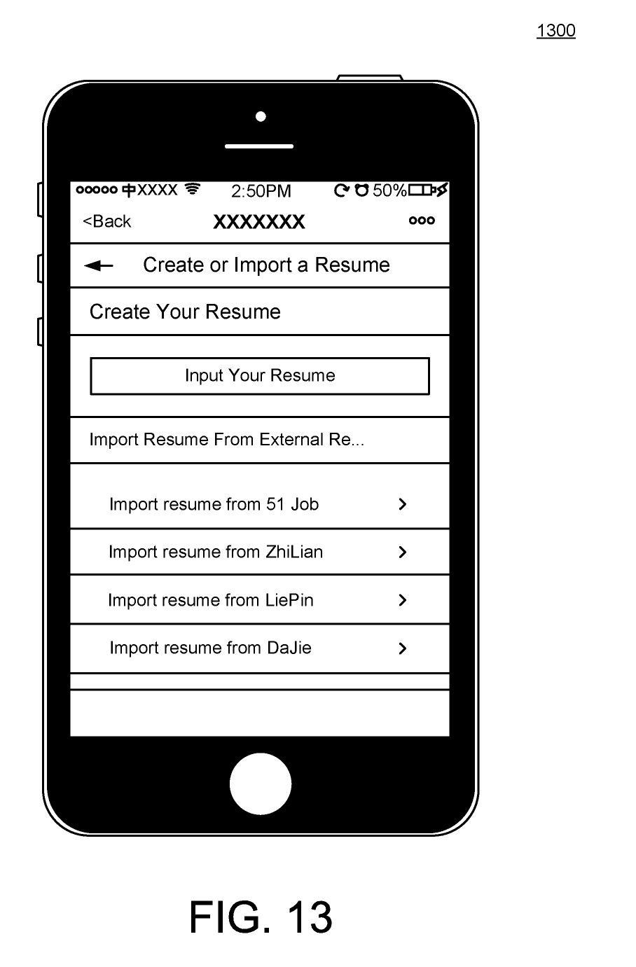

FIG. 13 shows an example mobile device UI screen 1300 of hiring service 201 that may be presented to mobile device users, in accordance with the principles of the present disclosure. Mobile device UI screen 1200 may include UI elements that allow an applicant to upload a resume from an online job board.

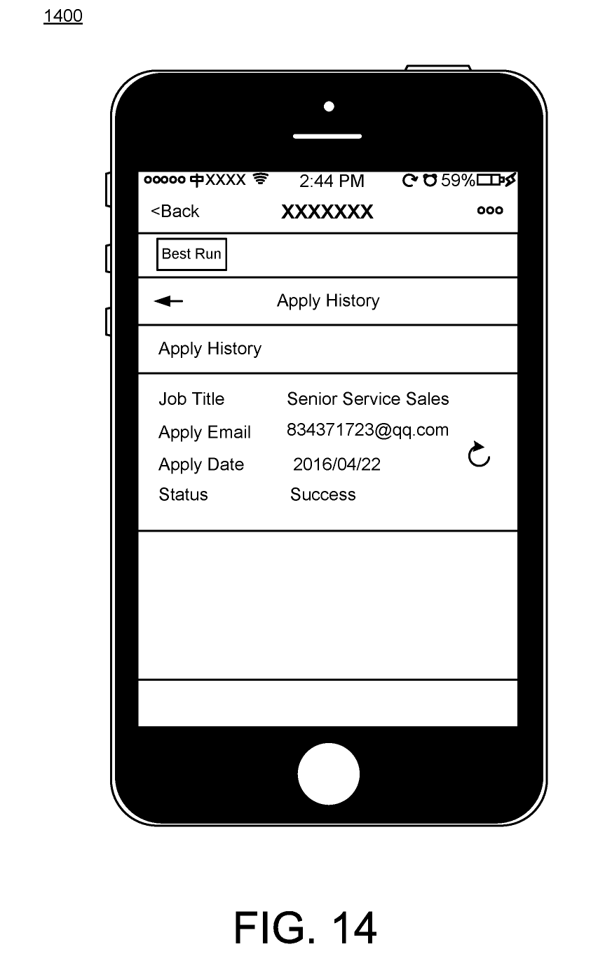

FIG. 14 shows an example mobile device UI screen 1400 of hiring service 201 that may be presented to mobile device users, in accordance with the principles of the present disclosure. Mobile device UI screen 1400 may include UI elements that allow an applicant to track application status.

The various systems and techniques described herein may be implemented in digital electronic circuitry, or in computer hardware, firmware, or in combinations of thereof. The various techniques may implemented as a computer program product, i.e., a computer program tangibly embodied in a non-transitory machine readable storage device, for execution by, or to control the operation of, data processing apparatus, e.g., a programmable processor, a computer, or multiple computers.

Method steps may be performed by one or more programmable processors executing a computer program. Method steps also may be performed by, and an apparatus may be implemented as, logic circuitry or special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Components of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a backend component, e.g., as a data server, or that includes a middleware component, e.g., an application server, or that includes a frontend component, e.g., a client computer having a graphical user interface or a Web browser through which a user can interact with an implementation, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a memory; and
a semiconductor-based processor,
the memory and the processor hosting a social media integration service for an internal human resources system of an organization,
the social media integration service coupling user interactions of an external social media platform with the internal human resources system of the organization.

2. The system of claim 1, wherein the social media integration service is hosted on a cloud computing platform that includes a database configured to store data received from the external social media platform.

3. The system of claim 1, wherein the social media integration service is configured to import resumes received at the external social media platform into a database of internal human resources system of the organization.

4. The system of claim 3, wherein the social media integration service is configured to:
receive a resume in one of several different formats;
parse the received resume; and
reassemble the parsed resume for import into the database of the internal human resources system of the organization.

5. The system of claim 1, wherein the social media integration service is configured to connect via an API to a local online job board that display job openings.

6. The system of claim 1 wherein the social media integration service is configured to connect via a user interface of a cloud computing platform to the internal human resources system of the organization.

7. The system of claim 1, wherein the social media integration service is configured to present an internal user interface with functions for an internal user of the internal human resources system of the organization and an external user interface with functions for a user of the external social media platform.

8. The system of claim 7, wherein the social media integration service is configured to present the internal user interface with user interface elements that allow the internal user to configure input data to be mapped to a required data format of the internal human resources system of the organization.

9. The system of claim 7, wherein the social media integration service is configured to present the external user interface with user interface elements that allow the external user to browse job openings published on the social media, filter the job openings, and apply for a job opening on the social media via the external user interface.

10. The system of claim 7, wherein the social media integration service is configured to present the external user interface with user interface elements that allow the external user to review and edit his or her resume.

11. A method comprising:
hosting, on a cloud computing platform, a social media integration service for an internal human resources system of an organization; and
using the social media integration service to couple user interactions of an external social media platform with the internal human resources system of the organization.

12. The method of claim 11, wherein the social media integration service is coupled to a database of the cloud computing platform configured to store data received from the external social media platform.

13. The method of claim 11, wherein the social media integration service is configured to import resumes received at the external social media platform into a database of internal human resources system of the organization.

14. The method of claim 13, wherein the social media integration service is configured to:
receive a resume in one of several different formats;
parse the received resume; and
re assemble the parsed resume for import into the database of the internal human resources system of the organization.

15. The method of claim 11, wherein the social media integration service is configured to connect via an API to a local online job board that display job openings.

16. The method of claim 11, wherein the social media integration service is configured to connect via a user interface of the cloud computing platform to the internal human resources system of the organization.

17. The method of claim 11, wherein the social media integration service is configured to present an internal user interface with functions for an internal user of the internal human resources system of the organization and an external user interface with functions for a user of the external social media platform.

18. The method of claim 17, wherein the social media integration service is configured to present the internal user interface with user interface elements that allow the internal user to configure input data to be mapped to a required data format of the internal human resources system of the organization.

19. The method of claim 17, wherein the social media integration service is configured to present the external user interface with user interface elements that allow the external user to browse job openings published on the social media, filter the job openings, and apply for a job opening on the social media via the external user interface.

20. The method of claim 17, wherein the social media integration service is configured to present the external user interface with user interface elements that allow the external user to review and edit his or her resume.
